(19) United States
(12) Patent Application Publication
(10) Pub. No.: US 2026/0140001 A1
(43) Pub. Date: May 21, 2026

(54) CONTACT SENSOR AND AUTOMATED SYSTEM USING SAME

(71) Applicant: MECHAVISION INC., Taipei City (TW)

(72) Inventors: CHANG-HO LIOU, Hsinchu City (TW); JUI-YIAO SU, New Taipei City (TW); YUAN-LI LU, New Taipei City (TW)

(21) Appl. No.: 18/253,929

(22) PCT Filed: Nov. 23, 2020
(86) PCT No.: PCT/CN2020/130876

§ 371 Date: Jan. 7, 2026

(51) Int. Cl. G01L 1/00; G05B 19/406

(52) U.S. Cl. CPC G01L 1/00; G05B 19/406

(57) ABSTRACT

A contact sensor comprising at least one unit contact accepting area thereon, for being disposed on a movable component of automated equipment, and electrically connected with a controller of the automated equipment to change a motion state of the movable component. The contact sensor includes a first contact sensing unit and a second contact sensing unit. The first contact sensing unit is located in the unit contact accepting area and has a first output terminal, and the first output terminal is electrically connected to the controller. The second contact sensing unit is also located in the unit contact accepting area and has a second output terminal, and the second output terminal is electrically connected to the controller.

### FIELD OF THE TECHNOLOGY

The present disclosure relates to a contact sensor, and in particular to a contact sensor that can greatly reduce the probability of failure, and an automated system using the contact sensor.

### BACKGROUND OF THE TECHNOLOGY

With the development of automated equipment, the safety of automated equipment has also received attention. For example, the safety mechanism of collaboration robots has become an important issue because of the close collaboration with operators. In recent years, the International Standards Organization has published ISO/TS 15066, which sets out further safety specifications for collaboration robots in robotic devices.

The contact detection mechanism is one of the safety mechanisms of automated equipment. With the addition of a contact detection mechanism, automated equipment can make an emergency response when it detects contact events. For example, referring to FIG. 1, which illustrates a conventional automated system 1 of the prior art having a contact detection mechanism is a collaboration robot system, including a controller 11, a movable component 12, a contact sensor 13, and a signal line 14. The movable component 12 is a movable robotic arm of the collaboration robot system, which can be controlled by the controller 11 for movement. The contact sensor 13 is disposed on the movable component 12, and electrically connected to the controller 11 by the signal line 14.

The signal line 14, which may include two wires, is respectively electrically connected to an input terminal and an output terminal of the contact sensor 13. The input terminal provides a voltage of the contact sensor 13, when the contact sensor 13 detects contact events, it will electrically conduct the input terminal and the output terminal so that the output terminal outputs the output voltage as a contact signal. Thus, the controller 11 receives the contact signal through the signal line 14, and instantly changes the motion state of the movable component 12, such as making the movable component 12 instantly stop moving, to prevent the movement of the automated system 1 from harming nearby collaboration operators.

### BRIEF SUMMARY OF THE INVENTION

The present disclosure provides a contact sensor for an automated system, which is designed to greatly reduce the probability of failure to ensure the safety of operators collaborating with the automated equipment.

In order to achieve the above object and more, in an embodiment of the present disclosure, a contact sensor is defined with at least one unit contact accepting area thereon, for disposing on a movable component of automated equipment, and electrically connected with a controller of the automated equipment to change a motion state of the movable component. The contact sensor includes a first contact sensing unit and a second contact sensing unit. The first contact sensing unit is located in the unit contact accepting area and has a first output terminal. The first output terminal is electrically connected to the controller. The second contact sensing unit is also located in the unit contact accepting area and has a second output terminal. The second output terminal is electrically connected to the controller.

According to an embodiment of the present disclosure, an automated system includes automated equipment, a controller, and a contact sensor. The automated equipment includes a movable component. The controller controls a motion state of the automated equipment. The contact sensor is for disposed on the movable component, electrically connected to the controller, and defined with at least one unit contact accepting area. The contact sensor includes a first contact sensing unit and a second contact sensing unit. The first contact sensing unit is located in the unit contact accepting area, and has a first output terminal and the first output terminal is electrically connected to the controller. The second contact sensing unit is also located in the unit accepting contact area and has a second output terminal, and the second output terminal is electrically connected to the controller.

In an embodiment, the first contact sensing unit and the second contact sensing unit are disposed side-by-side in the unit contact accepting area. In another embodiment, the first contact sensing unit and the second contact sensing unit are configured in a stacked manner in the unit contact accepting area.

In an embodiment, the first contact sensing unit may include two film layers, two electrode layers, a sensing layer, and a gap layer. The two film layers respectively have a first inner surface and a second inner surface corresponding to each other. The two electrode layers are respectively disposed on the first inner surface and the second inner surface, and the two electrode layers are separated by a gap. The sensing layer is disposed on one of the two electrode layers. The gap layer is disposed between the two film layers, so that the gap is formed between the two electrode layers. The sensing layer may include a pressure sensitive material, the pressure sensitive material includes at least one conductive material therein.

In an embodiment, the motion state may include a stop state, and a contact signal outputted by the first output terminal may be an on/off signal.

According to an embodiment of the present disclosure, the probability of failure of the contact sensor and the safety mechanism of the entire automated system may be greatly reduced, ensuring the safety of the operators collaborating with the automated system.

### BRIEF DESCRIPTION OF THE DRAWINGS

FIG. 1 is a schematic view illustrating a conventional automated system with a contact detection mechanism of the prior art.

FIG. 2 is a schematic view illustrating an automated system of an embodiment of the present disclosure.

FIG. 3 is a schematic view illustrating the automated system of an embodiment of the present disclosure.

FIG. 4 is a schematic view illustrating a first contact sensing unit of an embodiment of the present disclosure.

FIG. 5 is a perspective view illustrating a structure of a contact sensor of an embodiment of the present disclosure.

FIG. 6 is a perspective view illustrating the structure of the contact sensor of an embodiment of the present disclosure.

FIG. 7 is a perspective view illustrating the structure of the contact sensor of an embodiment of the present disclosure.

FIG. 8 is a schematic view illustrating the structure of the contact sensor of an embodiment of the present disclosure.

### REFERENCE SYMBOLS

1 conventional automated system
11 controller
12 movable component
13 contact sensor
14 signal line
2 automated system
21 controller
22 movable component
23 contact sensor
231 first contact sensing unit
231i first input terminal
2310 first output terminal
232 second contact sensing unit
232i second input terminal
2320 second output terminal
24, 24a, 24b signal lines
31a film layer
31af first inner surface
31b film layer
31bf second inner surface
32a electrode layer
32b electrode layer
33a sensing layer
33b sensing layer
34 gap layer
A unit contact accepting area
G gap
S11, S12 input signal lines
S21, S22 output signal lines

### DETAILED DESCRIPTION OF THE INVENTION

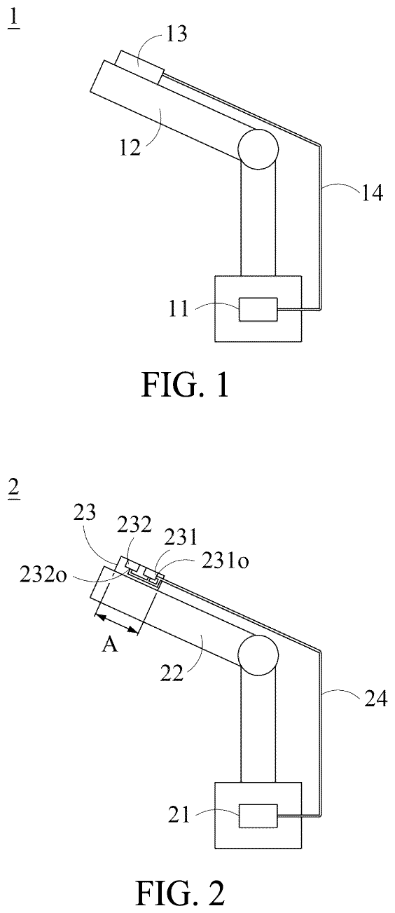

Referring to FIG. 2, an automated system 2 according to an embodiment of the present disclosure which is a collaboration robot system, including a controller 21, a movable component 22, a contact sensor 23, and a signal line 24 connecting the contact sensor 23 and the controller 21. In an embodiment, the controller 21, the moveable component 22, and the signal line 24 of the automated system 2 are the same as the controller 11 and the moveable component 12 and the signal line 14 in the prior art illustrated in FIG. 1, so the related description will not be repeated herein.

In an embodiment, the contact sensor 23 is for disposing on the moveable component, defined with at least one unit contact accepting area A (unitary touch region), and a first contact sensing unit 231 and a second contact sensing unit 232 are provided in the unit contact accepting area A. The first contact sensing unit 231 has a first output terminal 231o, and the second contact sensing unit 232 has a second output terminal 232o. In an embodiment, the unit contact accepting area refers to a minimum area where operators contact with the contact sensor 23, such as an area of one centimeter multiplied by one centimeter. In the present embodiment, the unit contact accepting area A is provided with two contact sensing units. Since the unit contact accepting area is the minimum area where the operators contact with the contact sensor 23, if the unit contact accepting area A is touched, the two contact sensing units will be actuated at the same time.

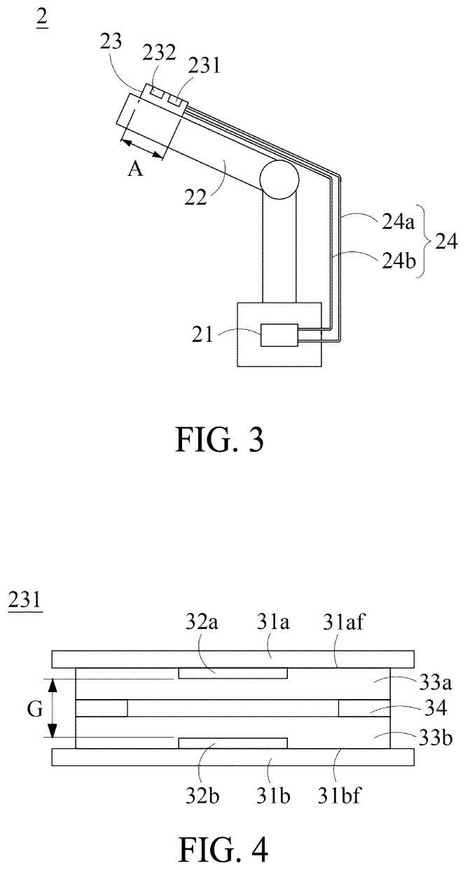

In an embodiment of FIG. 2, the number of signal lines 24 is illustrated by one. Refer to FIG. 3, which is an embodiment of an automated system 2 according to an embodiment of the present disclosure. In this embodiment, the number of signal lines 24 is taken as an example of two (24a, 24b), and the present disclosure is not limited thereto. That is, the embodiment of the automated system 2 of the present disclosure may have at least one signal line 24, and the number of signal lines 24 may be one or more.

Referring to FIG. 4, in an embodiment, the first contact sensing unit 231 includes two film layers 31a and 31b, two electrode layers 32a and 32b, two sensing layers 33a and 33b, and a gap layer 34. The two film layers 31a and 31b respectively have a first inner surface 31af and a second inner surface 31bf corresponding to each other. The two electrode layers 32a and 32b are respectively disposed on the first inner surface 31af and the second inner surface 31bf corresponding to each other and separated by a gap G. The two sensing layers 33a and 33b are respectively disposed on the corresponding electrode layers 32a and 32b. The gap layer 34 is disposed between the two film layers 31a and 31b, so that the gap G is formed between the two electrode layers 32a and 32b. The two sensing layers 33a and 33b may be a pressure sensitive material including a conductive material, and are coated or printed on the two electrode layers 32a and 32b.

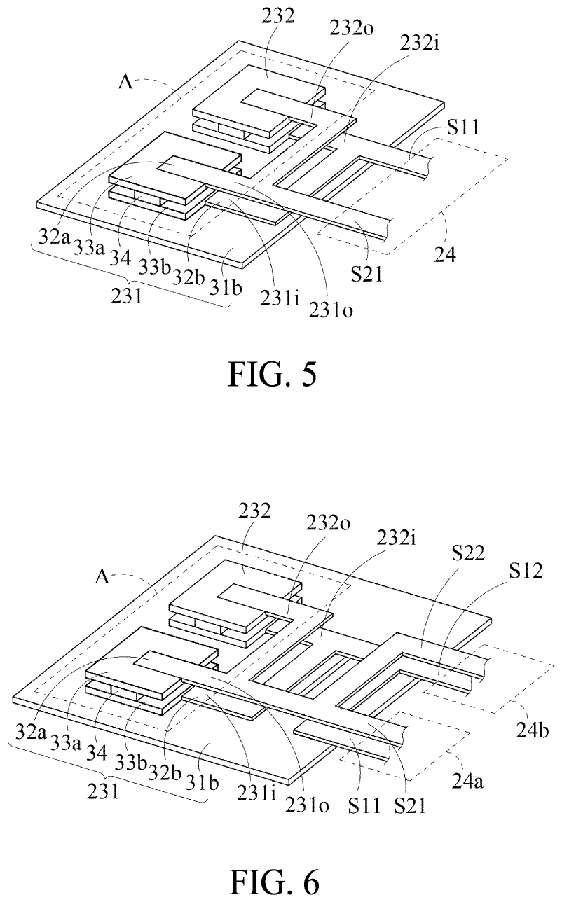

When the film layer 31a is contacted, it will be deformed by pressure, so that a distance between the two electrode layers 32a and 32b becomes shorter. The pressure sensitive materials of the sensing layers 33a and 33b are subjected to pressure, so that the conductive materials in the pressure sensitive material are in contact, forming a conductive path between the two electrode layers 32a and 32b. As illustrated in FIG. 5, the electrode layers 32a and 32b are respectively connected to the first output terminal 2310 and a first input terminal 231i. If the conductive path is formed between the two electrode layers 32a and 32b because of contact, the voltage received by the first input terminal 231i may be output from the first output terminal 2310 as a contact signal.

Referring to FIG. 5, in an embodiment, the first contact sensing unit 231 and a second contact sensing unit 232 are disposed side-by-side in the unit contact accepting area A defined by the contact sensor 23 (FIG. 2). In an embodiment, the second output terminal 2320 of the second sensing unit 232 is connected with the first output terminal 2310 of the first contact sensing unit 231 in the contact sensor 23, and the second input terminal 232i of the second sensing unit 232 is connected with the first input terminal 231i of the first contact sensing unit 231 in the contact sensor 23. The first output terminal 2310 is electrically connected to the electrode layer 32a, and the first input terminal 231i is electrically connected to the electrode layer 32b.

Based on this design, when the operator collaborating with the automated system 2 touches the unit contact accepting area A of the contact sensor 23, both the first contact sensing unit 231 and the second contact sensing unit 232 will output contact signals. Thus, even if one of the first contact sensing unit 231 and the second contact sensing unit 232 fails, there will be no situation where a contact signal is not output, i.e., the present disclosure greatly improves the safety of the automated system 2 by a contact sensor 23 having a multiplexed contact sensing unit. Further, since the first input terminal 231i and the second input terminal 232i are electrically connected in the contact sensor 23 and are connected with a single input signal line S11, the first output terminal 2310 and the second output terminal 2320 are also electrically connected in the contact sensor 23 and are connected with a single output signal line S21. Both the input signal line S11 and the output signal line S21 extend to the outside of the contact sensor 23, therefore, in an embodiment, the signal line 24 shown in FIG. 2 may be directly connected to the contact sensor 23 of the present embodiment without any design changes or transfers. In other words, in an embodiment, the signal line 24 only includes a single input signal line S11 and a single output signal line S21, and through the single input signal line S11 and output signal line S21 connecting with the first input terminal 231i, the second input terminal 232i and the first output terminal 2310 and the second output terminal 2320 respectively, the complexity of line configuration of the signal lines can be effectively simplified.

Referring to FIG. 6, in an embodiment, the same reference numerals as FIG. 5 are the same elements, and will not be repeated herein. The difference between FIG. 6 and FIG. 5 is in that there are two input signal lines S11, S12 and two output signal lines S21, S22. In an embodiment, the first input terminal 231i and the second input terminal 232i extend to the outside of the contact sensor 23 by two separate input signal lines S11, S12, and the first output terminal 2310 and the second output terminal 2320 extend to the outside of the contact sensor 23 by two separate output signal lines S21, S22. The input signal line S11 and the output signal line S21 form a signal line 24a electrically connected to the controller 21 (as shown in FIG. 3) and the input signal line S12 and the output signal line S22 form a signal line 24b electrically connected to the controller 21 (as shown in FIG. 3). Accordingly, in addition to the multiplexing of the contact sensing units 231, 232 being achieved inside the contact sensor 23, the contact sensor 23 of the present disclosure achieves the multiplexing of signal lines in the form of a plurality of signal lines 24a, 24b, in the manner of different signal lines 24a, 24b outputting the same set of contact signals. When one of the signal lines 24a, 24b fails, there will be no situation where a contact signal is not output. The present disclosure greatly improves the safety of the automated system 2 by the multiplexed contact sensor 23 and signal lines 24.

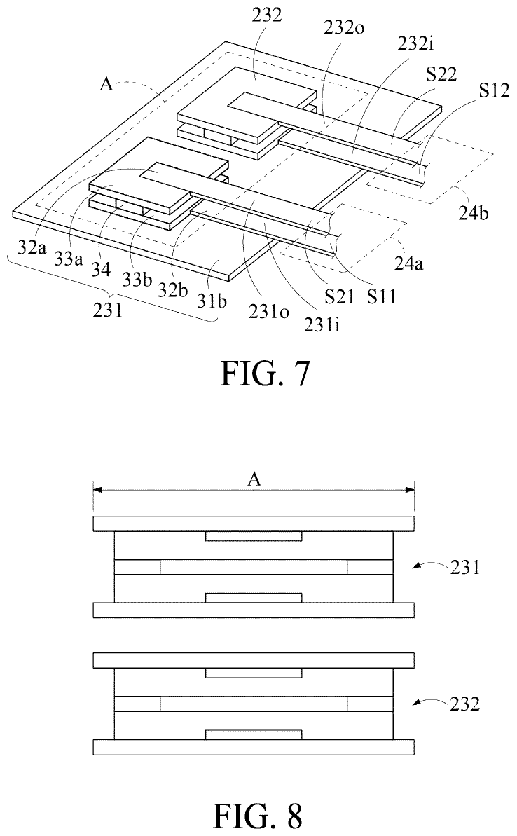

Referring to FIG. 7, in an embodiment, the same reference numerals as FIG. 6 are the same elements, and will not be repeated herein. The difference between FIG. 7 and FIG. 6 is in that the first contact sensing unit 231 and the second contact sensing unit 232 are independent and not electrically connected to each other, and electrically connected to the controller 21 through individual signal lines 24a, 24b (as shown in FIG. 3). Further, the first input terminal 231i of the first contact sensing unit 231 individually extends to the outside of the contact sensor 23 by the input signal line S11, the first output terminal 2310 of the first contact sensing unit 231 individually extends to the outside of the contact sensor 23 by the output signal line S21. The second input terminal 232i of the second contact sensing unit 232 individually extends to the outside of the contact sensor 23 by the input signal line S12 and the second output terminal 2320 of the second contact sensing unit 232 individually extends to the outside of the contact sensor 23 by the output signal line S22. The input signal line S11 and the output signal line S21 form a signal line 24a and the input signal line S12 and the output signal line S22 form a signal line 24b. In other words, the first input terminal 231i of the first contact sensing unit 231 is not electrically connected with the second input terminal 232i of the second contact sensing unit 232, and the first output terminal 2310 of the first contact sensing unit 231 is not electrically connected with the second output terminal 2320 of the second contact sensing unit 232.

Based on this design, when the operators collaborating with the automated system 2 contacts the unit contact accepting area A of the contact sensor 23, both the first contact sensing unit 231 and the second contact sensing unit 232 will output contact signals. Thus, even if one of the first contact sensing unit 231 and the second contact sensing unit 232 fails, there will be no situation where a contact signal is not output, which greatly improves the safety of the automated system 2. Further, since the first contact sensing unit 231 and the second contact sensing unit 232 are not electrically connected to each other, when one of them fails, it can be quickly detected outside the contact sensor 23, improving the convenience of the contact sensor 23 for maintenance.

Referring to FIG. 8, in an embodiment, the first contact sensing unit 231 and the second contact sensing unit 232 are configured in a stacked manner in the unit contact accepting area A. Similar to the illustration of FIG. 5, when unit contact accepting area A of the contact sensor 23 is touched, both the first contact sensing unit 231 and the second contact sensing unit 232 configured in a stacked manner with each other will output contact signals, so even if one of the first contact sensing unit 231 and the second contact sensing unit 232 fails, there will be no situation where a contact signal is not output, which greatly improves the safety of the automated system 2, thus greatly improving the safety of the automated system 2.

In an embodiment, the contact signal output by the contact sensor 23 is an on/off signal, not a complex signal such as a signal carrying communication packet data. Thus, the contact sensor 23 does not need to include elements required for numerical calculation, such as a processor or memory, to output a contact signal. This further reduces the risk of failure of the contact sensor 23. Further, when the contact sensor 23 is touched, since the contact signal is an on/off signal, the controller 21 does not need to encode and decode the contact signal, and can immediately change the motion state of the automated system 2, such as making the movable component 22 of the automated system 2 immediately enter a stop state. This design greatly improves the reaction speed of the safety device and reduces the probability of failure of the entire safety mechanism.

In an embodiment, the contact sensor 23 has one unit contact accepting area, and the unit contact accepting area is provided with two contact sensing units. However, those skilled in the art may change the number of unit contact accepting areas according to actual applications, or the number of contact sensing units set in each unit contact accepting area. For example, the contact sensor 23 may have four unit contact accepting areas, and each unit contact accepting area is provided with four contact sensing units, without departing from the spirit and scope of the present disclosure.

According to an embodiment of the present disclosure, the probability of failure of the contact sensor and the safety mechanism of the entire automated system may be greatly reduced, ensuring the safety of the operators collaborating with the automated system.

In summary, although the present invention has been disclosed as above by the embodiments, it is not intended to limit the present invention. Various changes and modifications may be made by those skilled in the art without departing from the spirit and scope of the present invention. Therefore, the protection scope of the present invention shall be defined by the attached claims.

1. A contact sensor with at least one unit contact accepting area thereon, and for being disposed on a movable component of automated equipment, and electrically connected with a controller of the automated equipment to change a motion state of the movable component, the contact sensor comprising:
a first contact sensing unit, located in the unit contact accepting area, and has a first output terminal, and the first output terminal is electrically connected to the controller; and
a second contact sensing unit, located in the unit contact accepting area, and has a second output terminal, and the second output terminal is electrically connected to the controller.

2. The contact sensor according to claim 1, wherein the first contact sensing unit and the second contact sensing unit are disposed side-by-side in the unit contact accepting area.

3. The contact sensor according to claim 1, wherein the first contact sensing unit and the second contact sensing unit are configured in a stacked manner in the unit contact accepting area.

4. The contact sensor according to claim 1, wherein the first contact sensing unit comprises:
two film layers, respectively having a first inner surface and a second inner surface corresponding to each other;
two electrode layers, respectively disposed on the first inner surface and the second inner surface and the two electrode layers are separated by a gap;
a sensing layer, disposed on one of the two electrode layers; and
a gap layer, disposed between the two film layers so that the gap is formed between the two electrode layers.

5. The contact sensor according to claim 4, wherein the sensing layer comprises a pressure sensitive material, the pressure sensitive material comprises at least one conductive material therein.

6. The contact sensor according to claim 1, wherein the motion state comprises a stop state.

7. The contact sensor according to claim 1, wherein a contact signal outputted by the first output terminal is an on/off signal.

8. The contact sensor according to claim 1, wherein the contact sensor is electrically connected to the controller by at least two signal lines, each of the signal lines comprises an output signal line, the first output terminal is connected with one of the output signal lines of the signal lines by contact, and the second output terminal is connected with another output signal line of the signal lines.

9. The contact sensor according to claim 1, wherein the first output terminal is connected with the second output terminal in the contact sensor.

10. The contact sensor according to claim 9, wherein the contact sensor is electrically connected to the controller by a single signal line, the single signal line comprises an output signal line, and the first output terminal and the second output terminal are electrically connected with the output signal line.

11. The contact sensor according to claim 9, wherein the contact sensor is electrically connected to the controller by at least two signal lines, each signal line comprises an output signal line, the first output terminal and the second output terminal are electrically connected with the output signal line of the at least two signal lines.

12. An automated system, comprising:
automated equipment, comprising a movable component;
a controller, controlling a motion state of the movable component; and
a contact sensor, defined with at least one unit contact accepting area thereon, disposed at the movable component and electrically connected with the controller, the contact sensor comprising:
a first contact sensing unit, located in the unit contact accepting area, and has a first output terminal, and the first output terminal is electrically connected to the controller; and
a second contact sensing unit, located in the unit contact accepting area, and has a second output terminal, and the second output terminal is electrically connected to the controller.

13. The automated system according to claim 12, wherein the first contact sensing unit and the second contact sensing unit are disposed side-by-side in the unit contact accepting area.

14. The automated system according to claim 12, wherein the first contact sensing unit and the second contact sensing unit are configured in a stacked manner in the unit contact accepting area.

15. The automated system according to claim 12, wherein the first contact sensing unit comprises:
two film layers, respectively having a first inner surface and a second inner surface corresponding to each other;
two electrode layers, respectively disposed on the first inner surface and the second inner surface, and the two electrode layers are separated by a gap;
a sensing layer, disposed on one of the two electrode layers; and
a gap layer, disposed between the two film layers, so that the gap is formed between the two electrode layers.

16. The automated system according to claim 15, wherein the sensing layer comprises a pressure sensitive material, the pressure sensitive material comprises at least one conductive material therein.

17. The automated system according to claim 12, wherein the motion state comprises a stop state.

18. The automated system according to claim 12, wherein a contact signal outputted by the first output terminal is an on/off signal.

19. The automated system according to claim 12, wherein the contact sensor is electrically connected to the controller by at least two signal lines, each signal line comprises an output signal line, the first output terminal is connected with one of the output signal lines of the at least two signal lines, and the second output terminal is connected with another output signal line of the at least two signal lines.

20. The automated system according to claim 12, wherein the first output terminal is electrically connected with the second output terminal in the contact sensor.

21. The automated system according to claim 20, wherein the contact sensor is electrically connected to the controller by a single signal line, the single signal line comprises an output signal line, and the first output terminal and the second output terminal are electrically connected with the output signal line.

22. The automated system according to claim 20, wherein the contact sensor is electrically connected to the controller by at least two signal lines, each signal line comprises an output signal line, the first output terminal and the second output terminal are electrically connected with the output signal lines of the at least two signal lines.
